(19) United States
(12) Patent Application Publication
(10) Pub. No.: US 2010/0211892 A1
(43) Pub. Date: Aug. 19, 2010

(54) Widgetized avatar and a method and system of creating and using same

(75) Inventor: Robb Fujioka, Manhattan Beach, CA (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(73) Assignee: FUHU, INC., El Segundo, CA (US)

(21) Appl. No.: 12/628,090

(22) Filed: Nov. 30, 2009

Related U.S. Application Data
(63) Continuation-in-part of application No. 12/592,207, filed on Nov. 20, 2009.
Application No. 12/592,207 is a continuation-in-part of application No. 12/381,663, filed on Mar. 13, 2009.
(60) Provisional application No. 61/207,980, filed on Feb. 17, 2009.

(51) Int. Cl. G06F 3/048; G06F 15/16; G06Q 20/00; G06Q 30/00; G06Q 10/00; G06Q 50/00

(52) U.S. Cl. 715/757; 705/44; 705/27; 705/10; 705/14.51

(57) ABSTRACT

An avatar is disclosed. The avatar includes computing code that provides for addition of the avatar as non-static content to at least two unique at least partially static web pages, and secondary computing code resident within the computing code, wherein the secondary computing code provides for association with at least one other portion of the computing code of: ones selected from a plurality of physical characteristics, ones selected from a plurality of clothes, ones selected from a plurality of accessories, a plurality of personal information, a plurality of preferences, and a plurality of recommendations.

### RELATED APPLICATIONS

This application is a continuation-in-part of U.S. patent application Ser. No. ______, entitled “A Widgetized Avatar And A Method And System Of Creating And Using Same” filed Nov. 20, 2009, which is a continuation of U.S. patent application Ser. No. 12/381,663, entitled “A Widgetized Avatar And A Method And System Of Creating And Using Same” filed Mar. 13, 2009, the entirety of which applications are incorporated herein as if set forth herein in their respective entirety. This application is further related to U.S. patent application Ser. No. ______, entitled “A Widgetized Avatar And A Method And System Of Virtual Commerce Including Same,” U.S. patent application Ser. No. ______, entitled “A Virtual Marketplace Accessible To Widgetized Avatars,” and to U.S. patent application Ser. No. ______, entitled “A Widgetized Avatar And A Method And System Of Creating And Using Same Including Storefronts,” all filed Nov. 30, 2009, the entire disclosures of which are incorporated by reference herein as if each being set forth in their entirety.

### FIELD OF THE INVENTION

The present invention is directed to avatars for use in computing communities and, more particularly, to a widgetized avatar and a method and system of creating and using same.

### BACKGROUND OF THE INVENTION

Many computing and entertainment embodiments allow for a user, player, or viewer to create an “avatar.” An avatar is typically a virtual manifestation of that user's “computerized physicality.” However, the prior art typically provides only limited options for a user who wishes to create an avatar, such as limited physical features, clothing, associated information, and the like. As such, a typical avatar allows for only very limited information about a user to be relayed by the avatar. More specifically, the physical characteristics of the avatar likely have only limited applicability to the physicality of the real-world user, due in part to the limited physical, clothing and the like options available in creating the avatar, and the typical information associated with the avatar, other than its physicality, is limited or non-existent.

Additionally, present avatars need to be created over and over again, and are highly variable for the same real user as between different applications using an avatar, in principal part because avatars are not typically transferable as between multiple applications. Further, present avatars present little or no monetization or marketing opportunities, nor do present avatars allow for collection of or provision to, potential transaction partners of the preferences, characteristics or interests of the actual user.

Thus, the need exists for an avatar, and an apparatus, system and method related thereto, that allows for transferability, improved physical relation to the actual user, more information regarding the actual user, and improved marketing, monetization and transaction opportunities related to the user's avatar.

### SUMMARY OF THE INVENTION

An avatar is disclosed. The avatar includes computing code that provides for addition of the avatar as non-static content to at least two unique at least partially static web pages, and secondary computing code resident within the computing code, wherein the secondary computing code provides for association with at least one other portion of the computing code of: ones selected from a plurality of physical characteristics, ones selected from a plurality of clothes, ones selected from a plurality of accessories, a plurality of personal information, a plurality of preferences, and a plurality of recommendations.

A system for creating an online persona, including a widgetized avatar, and recommending content for viewing by a user of the online persona is also disclosed. The system includes computing code that provides for addition of the avatar as non-static content to at least two unique at least partially static web pages, secondary computing code resident within the computing code, wherein the secondary computing code provides for association with at least one other portion of the computing code of: ones selected from a plurality of physical characteristics, ones selected from a plurality of clothes, ones selected from a plurality of accessories, a plurality of personal information, a plurality of preferences, and a plurality of recommendations, and, a recommendation engine employing suitable to suggest content based on at least one of a user's community, popularity, known expertise, clicks, interests, and searches.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates an avatar in accordance with the present invention;

FIG. 2 illustrates an avatar in accordance with the present invention;

FIG. 3 illustrates an avatar in accordance with the present invention;

FIG. 4 illustrates a plurality of avatars in accordance with the present invention; and

FIG. 5 illustrates a flow diagram in accordance with the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in typical avatar and computing apparatuses, systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

An avatar is understood by one of ordinary skill in the art to include a computer user's representation of him or herself, such as in the form of a two or three dimensional model used in computer games, social network applications, or other on-line communities. A typical avatar may further include, or have associated therewith, a user's name, a user's screen name, a handle, or text of interest, such as a trademark, saying, or poem, for example.

A widget in accordance with the present invention, and as will be understood by one of ordinary skill in the art, is a portable portion of code that may be installed or executed within any separate HTML based webpage by an end user without necessitating additional compilation of that code portion. Such widget code portions, in accordance with the present invention, are embeddable by the end user. As such, a widget in accordance with the present invention is any code portion that may be embedded by the end user within a selected page of HTML, XML, or like code that causes presentation of that selected web page. The widget, via the embedded code portion, thereby adds non-static content to the subject webpage.

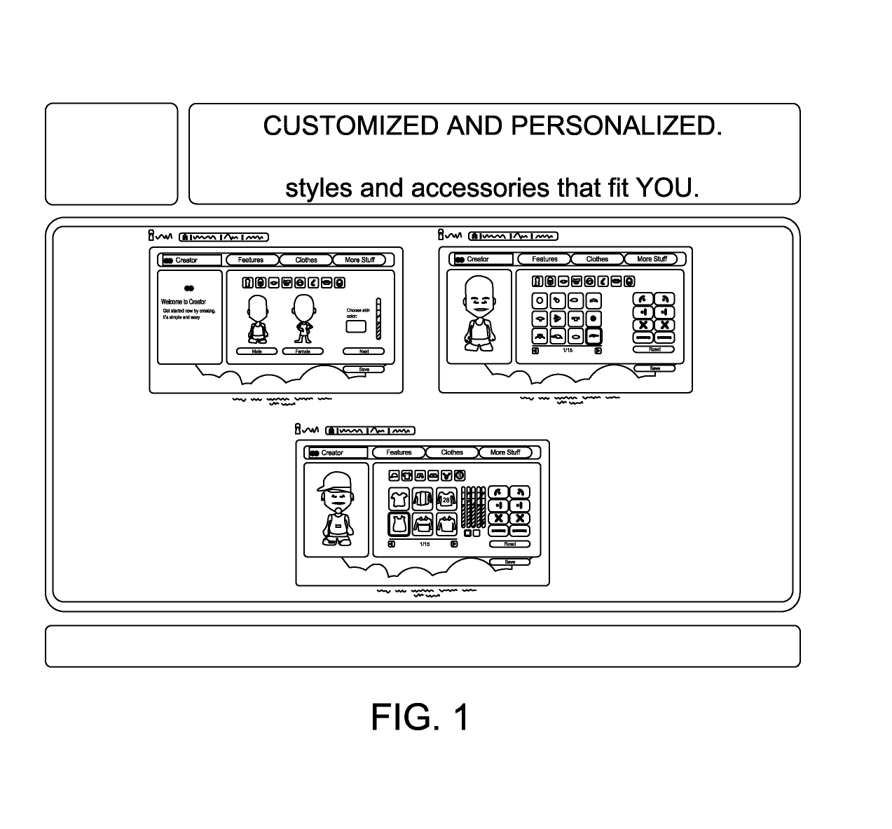

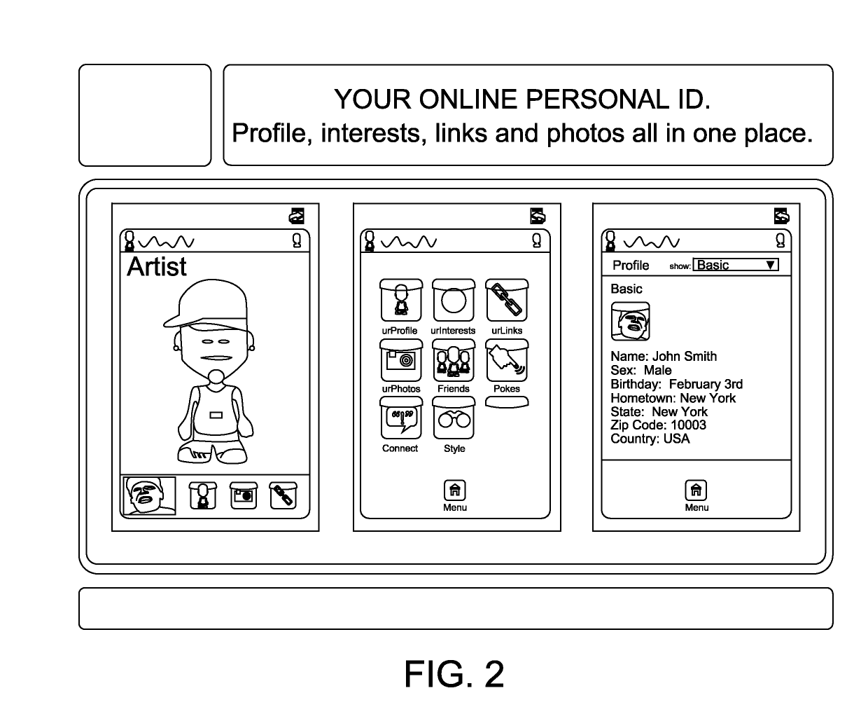

The present invention includes a fully portable, widgetized avatar having associated therewith multiple items of social information that are generally requested for association with at least two different computing communities or transactions. Widgetization of the avatar of the present invention necessarily allows for portability of the avatar of the present invention. For example, creation of a typical avatar in accordance with the present invention may include the association of physical features, such as facial and hair, with the subject avatar, as well as the aforementioned user name, as shown in FIG. 1. Further, a myriad of additional information may be associated with the avatar, wherein such information is generally required or desired for use in computing communities or transactions. This information may be organized into multiple levels of detail, and/or multiple levels of accessibility to third parties in a computing community or transaction. Such levels of accessibility may be selected by the creator of the widgetized avatar based on characteristics of the third party endeavoring to access the subject avatar. For example, a user may have basic information, which may be selectable for viewing by all registered users of a particular community, as shown in FIG. 2.

In an exemplary embodiment, a user may have likes or dislikes, such as musical or motion picture tastes, job or educational status, age, location, income, marital status, and other computed communities with which that user is associated, associated with his or her avatar. The present invention provides a physical manifestation of all of this information, such as in a “trading card” format. For example, FIG. 2 illustrates an avatar wherein the front of the virtual trading card includes an avatar having particular physical features, clothing, accessories, activities, and the like, along with an associated user name. However, when an interaction, such as selection of a drop-down menu, selection of a link, a double click, or the like is undertaken to “flip” a trading card to the back, a myriad of additional information is displayed regarding the user related to the widgetized avatar, such as age, interests, likes and dislikes, employment status, and the like.

Needless to say, because the virtual manifestation of the physical trading card is embodied in the computing code that provides for the virtual manifestation, such computing code may be provided in such a normalized format that it is easily adopted into multiple computing communities or environments, and/or may be adopted as non-static content onto multiple different web pages. As such, the subject avatar may be incorporated into multiple social communities, fantasy sports communities, blogs, and the like. Further, avatars of particular interest to the general public, such as trading card avatars of musical artists or other famous persons, may be downloaded or referenced by fans of such famous persons. Such avatars may, in fact, be presented in non-classical formats, such as through a tab presentation on a web page designed by the user as a home page in a certain community, or that is set forth by a particular computing community. Such “celebrity” avatars, including in such non-classical formats, may include presentations or allow for interactions with celebrity suggestions or favorites, such as recipes, music, concerts, movies, talk shows, reality shows, or the like, and may further allow for purchases from or related to such suggestions or favorites.

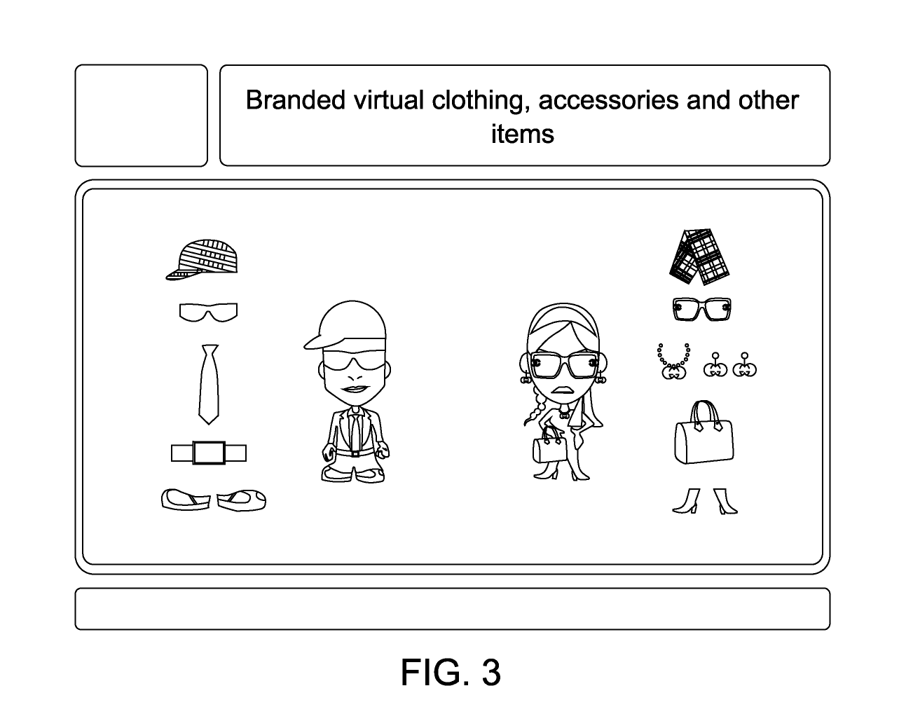

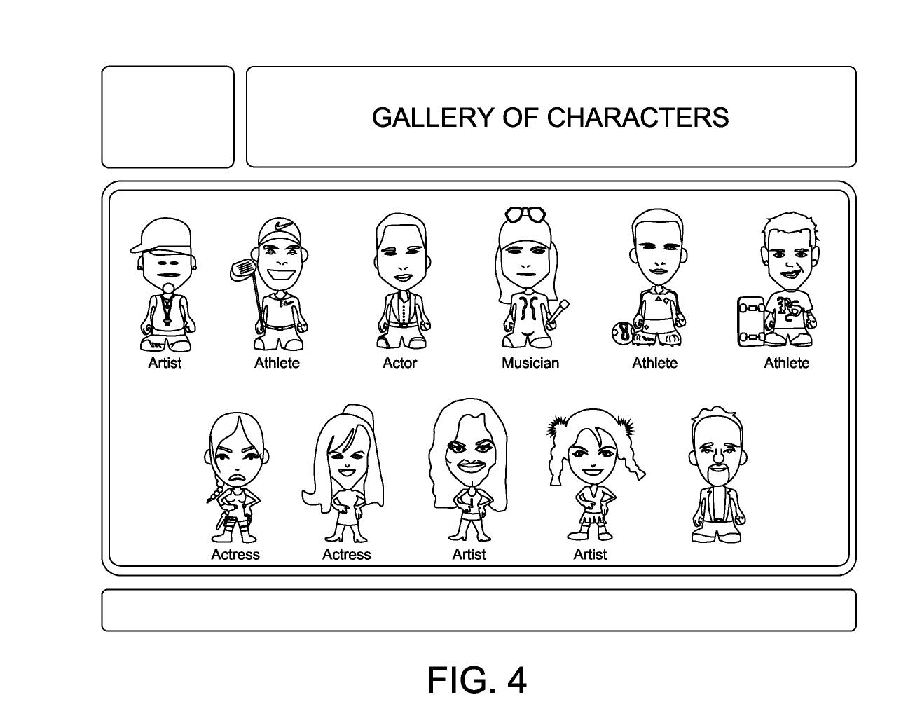

As referenced hereinabove, a typical avatar may have associated therewith certain physical features, clothing, accessories or activities, for example. As such, the present invention is and includes a tool whereby such physical features, clothing, accessories, and activities may be taken from the real world and “virtualized,” for use with a subject avatar, as shown in FIG. 3. For example, famous clothing lines, such as Vera Wang clothing, or famous shoe lines, such as Nike sneakers, or famous accessories, such as Kate Spade purses, or well known activities, such as playing for the Philadelphia Phillies, and goods at well known retailers, such as Tiffany's, Macy's, or the like, may be virtualized for use with an avatar. As such, virtualized items may be made available for sale for use with an avatar just as the corresponding real items are generally for sale for use with the real world user correspondent to the avatar. Likewise, celebrity avatars may be presented as “model” widgetized avatars, and the user may be enabled to purchase those items worn by the celebrity's avatar, and/or that are endorsed by that celebrity, as shown in FIG. 4.

Thereby, for example, during or following creation of a discreet widgetized avatar and/or a widgetized avatar to be associated with the aforementioned avatar trading card, the user creating the avatar may have available a selectable library of options for association with the subject avatar, such as a searchable library of options searchable by key word, or a hierarchal library of options presented by topic. Such libraries may be presented as “stores,” for example, in which the avatar may “shop.” For example, for “fashion”, a user may enter a fashion “shopping” environment, such as a virtual “mall,” to be presented with available virtual clothing lines for the avatar. Such lines may be visually presented by piece of clothing, or pieces of clothing on a shelf, for example, as would be the case in a real-world shopping for the real world user correspondent to the avatar. For example, for “shirts”, the user may be presented with options such as Jones New York, Tommy Hilfiger, Fubu, Major League Baseball, National Football League, and the like, and such options may be presented as storefronts, for example. The user may then select one of the presented fashion shopping points for shirts, and then may be presented with the entire line of “real world” shirts associated with that fashion line, but, of course in a virtualized format. Thus, for example, upon selection of a Major League Baseball store, the user may be presented with a series of major league baseball team jerseys for association with that user's avatar. Needless to say, the user may then select the baseball jersey of that user's favorite team, and may in fact pay, such as through the use of a micropayment, for the use of that virtual jersey just as the user might pay for the purchase of a real world jersey of that user's favorite baseball team in a real world store. Similarly, lines of pants, dresses, suits, shoes, and the like may be made available for use with avatars, and may in fact be made available for purchase by users for use with avatars. Likewise, accessories or activities that would require purchase in the real world by the user may additionally allow for purchase of such accessories or activities in the virtual world for use with the user's widgetized avatar.

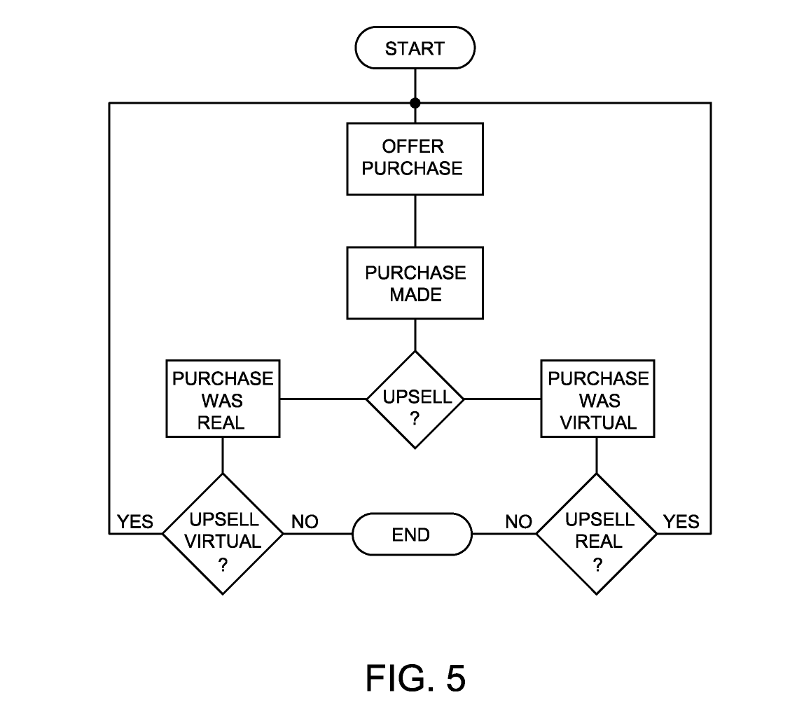

Additionally, the present invention may provide an upsell engine as illustrated in FIG. 5. The upsell engine may operate, upon purchase of a virtual item for association with the user's avatar, may present the user with an opportunity to purchase the same or similar article in the real world for real world use by the actual user based on that user's known preference for that article as evidenced by the purchase of the virtual article for use with the user's avatar. This may, of course, occur within an online store correspondent to the virtual store in which the avatar was “shopping.” The upsell engine may additionally or alternatively include presentation to the user of an advertisement for real world articles that are the same as or associated with the virtual article purchased by the user, or may allow for presentation of advertising related to likely related virtual or real world articles of interest to the user based on the user's expressed preference for the particular virtual article selected. Needless to say, the present invention may also be used to upsell in the inverse situation—that is, the situation in which the user purchases a real world article from a particular web site, or surfs a particular web site for real world goods and/or services, may cause the user to be presented with advertising for the purchase of the same or similar virtual articles, or associated or related virtual articles, or to be presented with a direct opportunity to purchase the same, similar, or related virtual articles at the point of purchase of the particular real world article.

More specifically, the purchase of real world goods may be intimately linked to the purchase of virtual goods and services, such as wherein an online purchaser of real world goods is offered the ability to purchase virtual goods, such as for the avatar discussed hereinthroughout. Alternatively, of course, the purchaser of virtual goods may be offered real world goods for use by the real world user correspondent to the avatar involved in the virtual purchase.

In such embodiments, the avatar may be advantageously associated with personal information related to the real world user, thereby providing an improved capability for involvement in virtual commerce. For example, the avatar of the present invention may, in or not within a trading card embodiment, associate information related to the real world user with the subject avatar. For example, financial information may be made available through the avatar of the present invention. More specifically, a series of credit card numbers, bank account access, electronic transfer of funds data, and the like may be associated with an avatar in the present invention, and access to such information may be limited by an administrator of electronic commerce in the present invention, or by a user, or uniquely for different users, for example. More particularly, access to a real world user's financial information, such as credit card information, through a subject avatar may be available only to online “stores.” In such an embodiment, only those sellers with the ability to offer an online purchase to a user may have access to the user's financial and/or purchase information, for example.

In typical embodiments discussed hereinthroughout, such as wherein virtual goods or services are purchased and real world goods or services are upsold, or wherein real world goods or services are purchased and virtual goods or services are upsold, the virtual goods or services in any transaction may be made via micropayments. Such micropayments may be made via the financial information provided in association with the avatar, as discussed hereinabove, and/or may be made, with or without need for user preauthorization, from an account associated with the personal information of the subject avatar, for example.

Thereby, personal information may not only be provided in association with the avatar, but may be accumulated in association with the avatar. For example, both virtual and real world purchases made by the avatar and/or the user of the avatar may be tracked and associated with the avatar account. Thus, preferences of and for the real world user, and preferences for the avatar, may be tracked and associated with the user account. For example, it would be readily apparent, whether or not such information was entered by the user of the avatar, that a user purchasing both real world and virtual goods of the same type, such as multiple music videos for association with an avatar trading card, wherein the videos are all related to the same artist, and multiple music downloads to the real world user related to that artist, or a Los Angeles Lakers jersey for an avatar, and real world Los Angeles Lakers jersey for the user, that the tracked interests indicate user preferences for certain goods or services, namely the particular music artist and the Los Angeles Lakers, in the example above.

As discussed herein, this tracked purchase information may be associated with the user information related to the particular avatar, such that the preferences of the user are known. Likewise, advertisement preferences of the user may be monitored and/or tracked through the use of the subject avatar, such as wherein the avatar is a widget as discussed hereinthroughout. Thereby, the particular user, and/or the users avatar, may be targeted based on preferences, such as through the presentation of targeted advertising, as the avatar of the user moves in the virtual realm, such as through the aforementioned mall, or through a series a store fronts, and/or as the user uses his or her avatar in the virtual realm, such as to purchase real world goods through online store fronts, for example. Such tracking is readily available, particularly wherein the avatar is widgetized, as will be understood by those skilled in the arts in light of the discussion herein. Such targeted offerings and/or targeted advertisements may, of course, be related to goods within the mall through which the avatar is touring, or may be related to goods and services outside the mall or for different topics, for example.

In the embodiments referenced above, for example, certain user criteria associated with the avatar, and/or tracked criteria and/or preferences of the user, may serve to provide limitations on admission to certain virtual locations. For example, only avatars associated with users having an annual income over a certain level may be provided with entry into a premium Rolex event in a virtual Rolex store within an avatar mall wherein such event may serve to sell virtual Rolexes for micropayments, and/or real world Rolex watches for use by the users associated with the avatar. Likewise, a Major League Baseball store front may provide entry to premium sales or premium virtual events only for users who have entered or been tracked to have interest in Major League Baseball. Needless to say, the aforementioned embodiments are exemplary only, and the avatar preferences and tracked preferences may serve to provide for entry, admission, authorization, or the like for virtual store fronts, virtual events, or the like.

Further, the present invention may allow for association of particular levels of expertise with particular areas of interest as related to the avatar trading card. As such, the user associated with the subject avatar may take a rating of that user's expertise in certain areas from computing community to computing community. Thus, searches may be made available in one or more computing communities for persons having desired levels of expertise in certain areas. The user may thus accumulate expertise points in multiple computing communities at the same time, wherein such points may be associated with that user's transferable widgetized avatar, whereby a user's expertise may rise based on accumulated expertise points. Additionally and alternatively, a user's expertise in a certain area may increase based on feedback from other users in one or more computing communities in relation to the subject users expertise in a particular area, or a user's expertise may increase based on an assignment of expertise levels by one or more of the computing communities, or a user's expertise level may rise based on advice offered, amount of advice offered, or purchase of expertise or advice from that user in or more on-line computing communities. Thus, a search by a party in need, such as a key word search, for an expert in a particular area and may not return a user advertising to be an expert in a particular area, but instead may return a user adjudged to be an expert in a particular area by parties other than that user him or himself. Of course, in accordance with the present invention, such expertise levels may be associated with the avatar or avatar trading card, and as such may be subsequently transferred to other computing communities.

Thus, the avatar of the present invention enables a user to create a portable, fully virtual “person” for association with that user and carrying the characteristics of that user, including a personal profile and identification card that can be used in combination with any web page, webtop or desktop and any computing community, transaction or social networking situation. Thereby, the avatar of the present invention allows users to connect with other users and share ideas, content, expertise, and applications. Further, the avatar of the present invention thus assists in viral growth by offering users of certain or multiple computing communities an avatar that keeps all personal profile information in one transportable place. Additionally, the avatars of the present invention may provide a foundation for a recommendation and expertise engine employing an algorithm that may suggest content or an expert based on a user's community, popularity, known expertise, clicks, interests, searches, or the like.

Thus, the avatar of the present invention may include one or more of the user profile, physicality of avatar, user personal characteristics, user interests, user links, user photos, videos, or audio, user friends, user sayings, jokes, or the like, user notes, connections or message postings, and user clothing, accessories, activities and general style. As used herein, the computing communities and transactions to which the avatar of the present invention may be transferred include all computing communities, including telecommunications communities such as those accessible from cellular telephones, televisions, and the like.

Those of ordinary skill in the art may recognize that many modifications and variations of the present invention may be implemented without departing from the spirit or scope of the invention. Thus, it is intended that the present invention covers the modifications and variations of this invention provided they come within the scope of the appended claims and their equivalents.

What is claimed is:

1. A plurality of computing code, associated over at least one network with a plurality of secondary computing code, for execution by one or more networked processors, comprising:
avatar code comprising code for providing a cartoon likeness of a user, accessories for the cartoon likeness, social community information of the user, and purchasing information of the user;
preauthorization code comprising code for preauthorizing first charges to the purchasing information for purchases of at least the accessories from at least one provider associated with the secondary computing code; and
authorization code comprising code for authorizing second charges to the purchasing information for purchases of goods for the user.

2. The computing code of claim 1, wherein said avatar code further comprises code for providing the cartoon likeness of the user, the accessories for the cartoon likeness, and the social community information of the user in a trading card format.

3. The computing code of claim 1, wherein the purchasing information comprises at least one of credit card numbers, bank account access numbers, and electronic transfer numbers.

4. The computing code of claim 1, wherein said preauthorization code further comprises code for preauthorizing a subset of available ones of the first charges.

5. The computing code of claim 1, wherein the secondary computing code comprises a virtual storefront.

6. The computing code of claim 1, wherein said authorization code further comprises code for preauthorizing a subset of available ones of the second charges.

7. The computing code of claim 1, wherein the first charges and the second charges comprise contemporaneous execution.

8. The computing code of claim 1, wherein the first charges comprise an upsell from the second charges.

9. The computing code of claim 1, wherein the second charges comprise an upsell from the first charges.

10. The computing code of claim 1, wherein the first charges comprise at least one micropayment.

11. The computing code of claim 1, wherein said avatar code comprises a widget.

12. The computing code of claim 11, wherein the widget comprises a tracking widget.

13. The computing code of claim 12, wherein the tracking widget comprises a preference tracking widget.

14. The computing code of claim 13, wherein the tracking widget comprises a targeted advertising generator.

15. The computing code of claim 1, wherein the secondary computing code comprises a virtual mall comprised of a plurality of virtual storefronts, each associated with one of the at least one providers.

16. The computing code of claim 1, wherein the purchasing information comprises a limitation on the avatar code.

17. The computing code of claim 16, wherein the limitation comprises a limitation on admission.

18. The computing code of claim 1, wherein the accessories comprise clothing.

19. The computing code of claim 1, wherein the goods comprise clothing.

20. The computing code of claim 1, wherein the secondary computing code comprises at least one widget.
